(19) United States
(12) Patent Application Publication
(10) Pub. No.: US 2024/0312354 A1
(43) Pub. Date: Sep. 19, 2024

(54) INTERNET OF THINGS-BASED TRANSPORTATION SHUTTLE AND SHUTTLE TRAFFIC SYSTEM

(71) Applicants: Zhongrui Chen, Beijing (CN); Jingchao Chen, Qingdao (CN)

(72) Inventors: Zhongrui Chen, Beijing (CN); Jingchao Chen, Qingdao (CN)

(21) Appl. No.: 18/575,441

(22) PCT Filed: Jul. 7, 2022
(86) PCT No.: PCT/CN2022/104478

§ 371 Date: Dec. 29, 2023

(30) Foreign Application Priority Data
Jul. 23, 2021 (CN) 202110860506.X

(51) Int. Cl. G08G 7/00; G06Q 10/047; G16Y 40/30

(52) U.S. Cl. CPC G08G 7/00; G06Q 10/047; G16Y 40/30

(57) ABSTRACT

The present invention defines and constructs an Internet of Things-based transportation shuttle and shuttle traffic system (STS), which relate to the technical field of transportation, transportation devices and traffic systems. Transportation shuttles, shuttles integrated STS, risk separation, separation of operation and control, joint intelligent control, de-consolidation de-identification de-signal lights, full interchange, standard modules, stations/stops insertion, seamless connection, fully enclosed 24/7 in all weathers, unlimited speed, driverless, one-stop arrival, online parking, priority/concession handling, and intelligent control linkage for the real-time monitoring of shuttles, automatic control and optimization of routes, resource utilization and system balance and other solutions are used to ensure the safe, efficient and optimal operation of STS, which solves traffic problems such as peak bottlenecks, low capacity, many accidents, weather effects, resource waste and environmental pollution, and creates future transportation devices and traffic systems that are extremely simplified and standardized, share resources, and are globally accessible.

### FIELD OF THE INVENTION

The invention herein relates to a transportation vehicle and a traffic system, and in particular relates to a Shuttle and a Shuttle Traffic System that are based on Internet of Things (IoT).

### BACKGROUND OF THE INVENTION

### Current Mainstream Technologies:

1. Current traffic systems (all traffic systems mentioned in this paper refer to land traffic systems, abbreviated as TS) consist of two main types (collectively abbreviated as 2TS): TTS (Traditional Traffic System), and ITS (Intelligent Traffic System).

2. 2TS Framework Setting: The macro-framework mode of 2TS and the vehicles it covers is the Operation and Control Intersecting (OCI) mode, i.e., high-speed and high-risk transportation vehicles, the traffic police, traffic signs, facilities, etc., which control traffic safety and order, and other vehicles, drivers, pedestrians, weather, and even small animals, etc., are all on the open, open road, and their trajectories cross and influence each other.

3. 2TS constituent elements: The 2TS constituent elements are: people, vehicles, roads and environment in four major areas. The strongly related subdivision factors include: road network, vehicles, drivers, passengers, pedestrians, traffic police, signals, traffic signs, monitoring facilities, safety protection, public places (only the densely populated areas related to transportation. For example, transportation hubs, train stations, subway stations, bus terminals, some bus stops and cars, etc.), vehicle management, driver training, supporting services, traffic regulations, etc.

4. ITS and TTS development: ITS and TTS have obvious homogeneity. Under the premise that the traditional road network form, basic structure of vehicles and transport mode remain unchanged, ITS only simply and partially embeds intelligent functions and facilities to vehicles and roads in terms of convenience, such as, electronic payment, traffic information application, GPS positioning, partial data collection, etc. Parking and driving are still manually driven, and still every family has a car and travel by car. ITS and TTS do not take into account the important aspects that lead to traffic bottlenecks (number of travelers, vehicle ownership, traffic load, etc.), and not only fails to solve, but also increasingly aggravate traffic problems such as traffic congestion and derived problems.

### Four Major Global Traffic Problems:

1. Severe congestion and increasing overall traffic pressure during peak hours:
2. Many traffic accidents and huge loss of life and property:
3. Low system efficiency and high time cost and high empty rate (Note: Empty rate means the proportion of empty seats or empty loads to the load when the vehicle is in operation).
4. Serious environmental pollution, serious waste of resources and insufficient resources:

CHARACTERISTICS AND PROBLEMS OF CURRENT MAINSTREAM TECHNOLOGIES (The further specified problems from this section are the specific technical problems to be solved by the invention herein, and are expressed in the “THE SPECIFIC TECHNICAL PROBLEMS TO BE SOLVED” section of the “OBJECT AND SUMMARY OF THE INVENTION”.):

1. The Characteristics and problems of transport mode and transport process: transport mode is consolidation, and the transport process is Relay Type. Consolidation manifests itself in both centralized terminus and vehicle large-scale, while stations/stops are designed to match the form and layout of consolidation. Relay Type performance: (bulk passenger or bulk cargo) each from the starting point—gathered to the originating terminus—departing by vehicle (most of them have temporary boarding or alighting en route)—arrive End terminal—transfer intermodal diversion (may be multiple times)—to their respective end points, and mostly regular departures and fixed routes (Note: Route, line, and path are used synonymously in this application, i.e., a combination of different lanes and/or sections of roadway). It is not the true meaning of One-Stop Arrival.

Note 1: In the invention herein, One-Stop Arrival includes two meanings of transport mode (referring to the technical solution) and/or transportation effect (referring to the effect of the solution), the exact meaning depends on the context before and after. Note 2: One-Stop Direct that people often talk about and One-Stop Arrival used in the invention herein are completely different in their ways and effects: In the former case, all passengers get on and depart collectively from a terminus, arrive directly at next terminus and get off collectively, but the pick-up and drop-off stations/stops are usually not the origin and destination of the passengers, and most of them still need to multiple transfer. The latter is that individual passengers get on the Shuttle from any nearest station/stop, and directly arrive at another station/stop and get off, the drop-off point is the passenger's destination, and there is no need to transfer between the origin and the destination. The latter is the real meaning of One-Stop Arrival.

2. Characteristics and problems of control: For vehicles and pedestrians traveling freely on the open road without separation, the measures used, such as signals, signs, traffic police, regulations, capture, speed limit, etc., present the characteristics of weak order, weak right of way, weak monitoring, weak predetermination, human control, no error prevention, and many causes of accidents. no advance sensing, no collection and analysis, no pre-correction, no follow-up correction.

3. Characteristics and problems of the road network: the road surface is open, unsealed, less separated, and Vehicle Exposure; the road condition is Pedestrian-Vehicle Mixed-Traffic, and Crossed-Trajectories, with many influencing factors and many combinations of accident causal chains and changes at any time; the road network has many intersections, few interchanges, and different complexities and qualities. This is the key link of the accident causal chains.

4. Characteristics and problems of vehicles: many models, large size, complex structure, many component systems; performance, condition, speed and load capacity vary greatly; mostly wheel systems and fuel driving, driver-driven; Very few vehicles are designed to connect seamlessly to a specific area.

Note: Specific Areas are, airports, terminals, railway stations, bus terminals and other air, land and sea hubs and stations, subway stations, large shopping malls, CBD, large scenic areas, important attractions or amusement parks, parks, large residential areas and all other densely populated areas; vehicle manufacturing, management, maintenance, cleaning, traffic system operations and maintenance and other related areas; hospitals, schools and kindergartens, government, military sites, police sites and other important areas; Smaller spaces such as buildings, homes or wards; other areas that need to be connected.

5. Characteristics and problems of driver: At least one licensed driver with manual driving risk per vehicle.

Note: Manual Driving Risks, including but not limited to: Fatigue driving, drunk driving, road rage, red light running and other kinds of violations, and drivers vary greatly in all aspects of their individuality, the lack of operational accuracy and persistence, easier to misuse in new road conditions or sections, more difficult to handle in advance, etc.

6. Characteristics and problems of pedestrians: Sharing the right-of-way with vehicles, Crossed-Trajectories of pedestrian and vehicles.

7. Characteristics and problems of traffic police: Traffic police are provided for on-site control of vehicles and traffic.

8. Characteristics and problems of signs: Various signs and signals are installed on the roadway, in the air, and on both sides of the roadway.

9. Characteristics and problems of monitoring facilities: The focus is on recording driver and vehicle violation facts in a discontinuous distribution. No comprehensive analysis, proactive prediction, early correction or error prevention features, no feature that provides front-loaded, safe and reliable real-time information to the driver.

10. Characteristics and problems of safety protection: Partial separation of reverse traffic flow; few separation measures between pedestrian and vehicles and between vehicles in the same direction; no technology to separate weather from roads and vehicles.

11. Characteristics and problems of public places: Setting up many public places and large gathering of passengers.

12. Characteristics and problems of Parking Spaces: Each vehicle needs to be allocated 2 fixed parking spaces (residential and work sites), and a certain amount of public parking spaces.

13. Characteristics and problems of energy and environmental protection: Fuel is the energy source for most vehicles and has low energy efficiency.

14. Characteristics and problems of mutual interference: There is mutual interference and intensification between the above-mentioned items.

### OBJECT AND SUMMARY OF THE INVENTION

### Object of the Invention

Based on the IoT+Internet+Communication Network+Big Data (or IICB), invent an IoT-based Transportation Shuttle and Shuttle Traffic System to solve the urgent traffic problems faced by the global transportation, get rid of the traffic dilemma completely, and construct a future, green and sustainable transport.

Note 1: Transportation Shuttle, which is a kind of transportation carrier that is based on Internet of Things (IoT), lightweight miniature streamline form levitation state, all weathers full-automated driverless within a pipeline network, Online Driving and Online Parking, high-speed, One-Stop Arrival, referred to as Shuttle. The Shuttle takes the shuttle shape as an example, but is not limited to the shuttle shape, and is used the term Shuttle System when expressing the overall composition of the Shuttle. It removes the vast majority of the composition and characteristics of existing cars or trains, and is a brand-new type of transportation machine, the detailed composition and characteristics of which as well as being vastly different from those of existing vehicles are described in detail below. Note 2: Shuttle Traffic System, which is a kind of new business format of traffic system that is Shuttles seamlessly connecting to a Specific Area by organically integrating with the pipeline network and other constituent elements of the traffic system, dynamically optimizing routes by Joint Intelligent Control of transportation, emergency response and services, and, Online Driving and Online Parking, all weathers automatic high-speed and efficient, One-Stop Arrival. Referred to as Shuttle Traffic or STS. It rejects many of the constituent elements of the existing vehicles and the 2TS as well as the peripheral facilities and functions, and greatly simplifies the 2TS and its detailed composition and features and the differences between 2TS. It greatly simplifies the 2TS and peripheral facilities, and its detailed composition and characteristics are different from those of 2TS, as described below.

### The Specific Technical Problems to be Solved

1. Lack of effective technical means to increase transportation capacity, in particular, there is a lack of technical means to eliminate peak traffic bottlenecks. This is the first comprehensive problem to be solved, and it is a problem that can be solved by solving the following problems
2. Transport mode of consolidation and the many problems arising from it.
3. The travel route is fixed and speed is limited.
4. Public transportation detours, intermittent timed departures, in and out of en-route stops, and transfers.
5. Manual Driving.
6. Manual control of traffic and no error-proof.
7. Public places are laid out for the purpose of collecting and transferring transportation.
8. Inconsistent standards, inconsistent quality for the road network and vehicles.
9. Fuel or electric forms of energy and accompanying fuel or batteries, numerous and heavy components, and mechanical driving methods.
10. Failure to separate weather from vehicles and roads.
11. Speed limits, limits that are too low, limits that are variable.
12. Vehicle Exposure, Pedestrian-Vehicle Mixed-Traffic, and right-of-way conflicts.
13. Signs, Signal lights and signal switching.
14. Drop-off and pick-up patterns at way stations.
15. Relay Type transportation with multiple transfers is used, and there is no technical means of direct transportation from one stop.
16. Too many components of conventional vehicles and 2TS, and too many causes of traffic accidents, they are weakly controlled, or even uncontrolled.
17. Without error-proofing.
18. Vehicles are designed to be of multiple types and models, large or in trains, multiple people in one vehicle or centralized, driver-driven, with no information transfer channels to each other, and designed for low speeds. (Note: The invention herein relates to solving this problem without involving specialty vehicles and truckload trucks).
19. 2TS monitoring and control lacks data, predictability, antecedence, immediacy and effectiveness. That is, lack of data collection, analysis and prejudge in advance for pedestrian flow, road conditions, vehicle conditions and road network, Lack of measures for proactive prevention, diversion and error-proofing to prevent traffic congestion, and inability to provide safe and fast optimization solutions for each vehicle trip.
20. Lack of guaranteed means of Priority/Concession (or P/C).
21. Configure offline parking spaces.
22. Excessive weight of single vehicle, many seats or large load, complex structure, mostly on wheels to move on the highway or railroad tracks.
23. Failure to establish seamless linkages with specific regions, and failure to form intelligent joints with linking up cross industries.
24. Lack of technical means to reduce the serious waste of time resources, natural resources, and social resources.

### New Feature Technology to be Add:

1. P/C
2. Lock and force the transfer.
3. Data acquisition and travel recommendation.
4. Dedicated vehicle sharing.
5. Online Driving and Online Parking.
6. Automatic emergency response to fire and automatic sprinkler.
7. Unobstructed emergency rescue.
8. Error-proof.
9. Passenger status monitoring.
10. Road condition judgment.
11. Passenger health monitoring.
12. Billing charges for ticket-free cloud payment.

### Detailed Description of the Invention's Technical Solutions

### Technical Solutions for the Above-Mentioned Object of the Invention, the Specific Technical Problems to be Solved and the New Functional Technology to be Add:

1. Separation of Operation and Control (SOC): It overturns the 2TS model, and reconstructs the STS compositional framework mode into “1+3” transport mode of SOC, i.e., 1 transport body+3 intelligent control linkages, two major parts. The 1 transport body refers to Shuttle-tunnel System, in which the Pipeline System formed road network through Separation Pipeline, the road network is fully-enclosed or semi-enclosed, full interchange, and in which the Shuttle is MLMD and driverless carrier (note: MLMD abbreviated for Magnetic Levitation and Magnetic Driving), Shuttle-tunnel System is the key breakthrough of the entire STS framework, making it possible to break the peak bottleneck and traffic pressure. The 3 intelligent control linkages are the Control-Safeguard System, Data System, and Emergency System, which ensure the safe, efficient, and optimal operation of the transport body. And the overall STS operation is all non-manual mode. It forms a fully enclosed, all day, all weathers, unlimited speed, intelligent control, driverless, One-Stop Arrival traffic mode. This technical solution provides direction for the proposed entry points of the following technical solutions and guarantees the feasibility of technical solution implementation.

2. Systems Complementary: STS and 2TS co-exist, with STS mainly carrying passengers and divisible small cargos, and 2TS wheel system mainly carrying large cargos, complementing each other.

3. The technical solutions 1, 2 and the following technical solutions are combined to solve the technical problem No. 1. At the same time, to solves or/and synergistically solves the following corresponding problem or/and added function of each article independently (Note: Synergistically solved means: different technical solutions are combined to solve the same numbered technical problem or/and added function).

4. Separation Pipeline: From the perspective of safety and speed, the system is separated from the static and dynamic, i.e., in all the transportation lines, the enclosed pipeline system is used as a protective shield, which completely separates the high-risk moving shuttles from the external elements, such as pedestrians, other vehicles, and weather effects, and greatly reduces the causes of accidents, and completely blocking the causal chain of the important accident factor of high-speed moving Shuttle and the risks it brings. And by full interchange, de-signal lights and de-signposted, it provides space for the Shuttle to travel at high speed in the enclosed pipeline all day and all weathers without obstacles, online parking, and other hardware deployment. The Pipeline and Shuttles together constitute a complete Shuttle-tunnel System, forming a Hard Body of protection and transportation, which is the transport body and framework core of STS, not only to separate the risk, reduced travel space and lane widths and heights, but also to improve the speed of the vehicle, but also to provide parking spaces and hardware spaces, STS elements are also reduced to the Pipe-Tunnel System, Shuttle, passenger and cargo, wired and wireless channel, Intelligent Control System, and there is no movement Crossed-Trajectories between the elements. Solve the technical problems No. 1, 8, 10, 11, 12, 13, 16, 17, 21, 24 and the new features No. 5, 8.

5. Lightweight Miniature Streamline Shuttle: The Shuttle is different from conventional vehicles, it is a lightweight miniature streamline form transport equipment with standard modularity. It removes most of the functional systems from conventional vehicles (such as, steering and handling, engine/motor and starter, transmission, driving, braking, suspension, wheels and spare tire, fuel tank, cooling, exhaust, exterior lights, a variety of mechanical linkage, engine compartment and trunk, etc.), weight and volume compared to conventional cars are reduced by about 80%; it consists of the Shuttle Body System, Levitation-Driving System, Standby Driving System, Shuttle Positioning System, Air Conditioning System, Lighting System, Audio-visual Interactive System, In-Shuttle Sensing System, Shuttle Safety System, Identification System, In-Shuttle Communication System, Shuttle Intelligent Control System, Wiring Harness System, Seat System; Shuttle belongs to the total invention idea STS inseparable part, Shuttle is controlled by STS Intelligent Control System and is classified into Passenger Shuttle and Cargo Shuttle; Passenger Shuttle with a load of no more than 4 persons and an optimized load of 1+1 persons or limited cargo (i.e., quasi-single person ride: 1 main passenger, seated or reclined, with 1 rear seat for another person or luggage), with the possibility of exclusive rides alone and voluntary carpooling to minimize empty loads, and it also makes it easier to take care of the elderly, the young, the sick, the disabled and the pregnant, or for others to ride with them, saving resources, increasing capacity and lowering fares; Cargo Shuttle can be used for quick loading or loading of bulk cargo in miniature containers with limited cargo loads; Shuttle can enter Specific Areas, especially small space areas, Shuttle can be connected to each other, MLMD and Magnetic Braking, driverless; due to the changes in road conditions, Shuttle's driving route and speed, distance between the front and rear shuttles, parking spaces will be adjusted in real-time and changed dynamically, these adjustments and changes are based on the principles of shortest time duration, no stopping en route and optimal system resources, and judged and commanded by the Intelligent Control System; Shuttle is the transport body and framework core of STS. Solve the technical problems No. 1, 2, 3, 4, 5, 7, 8, 9, 14, 16, 18, 21, 22, 23, 24 and the new functions No. 1, 2, 3, 4, 5, 9, 11, 12.

6. One-Stop Arrival: Eliminating restrictions on the operation of intra-city and inter-city vehicles and transfer transport mode, and allowing Shuttles to travel, stop, and park anywhere on the road network. This plays the role of shunting and reducing the number of staff at congested stations/stops, cutting peaks and filling valleys, and eliminating the additional passenger flow gathered by transferring at transit stations, so that any person can take a Shuttle to depart from any station/stop at any time, eliminating the need for waiting, stopping, accompanying and transferring, etc., and reaching the destination at the drop-off point. Solve the technical problems No. 1, 2, 3, 4, 7, 10, 14, 15, 16, 20, 23, 24 and the new features No. 1, 2, 3, 4.

7. Joint Intelligent Control: Using the information and communication network based on IICB, it links STS components such as energy, Pipeline, Shuttle, passengers, central control and peripheral services together to form a Joint Intelligent Control System, i.e., Soft Combination of control and service. Among them, the Intelligent Central Control System communicates instantly with each part of the system, sends commands to each element and obtains the feedback information from each element, and then regulates and controls the IoT terminals in the whole system automatically, and jointly to ensure that all the components of STS operate in concert; moreover, the Intelligent Control System makes judgment based on the principle that the Shuttle traveling route and speed take the shortest time duration, no stopping en route and system resources are optimal, in order to optimize the utilization rate and balance of no stopping en route, speed, and traffic system related resources in real time, and to provide commands for the Shuttle, so that the operation status and vehicle condition of each Shuttle is the comprehensive result of the interaction between the Shuttle and the operation status and system status of a certain range of Shuttles, and is also the basis for the Intelligent Control System to issue the operation commands, so that the Shuttles are in a real-time interactive response mode with the other elements of STS. Solve the technical problems No. 1, 3, 4, 5, 6, 13, 16, 17, 18, 19, 20, 21, 24 and the new features No. 1, 2, 3, 4, 5, 6, 7, 8, 9, 10, 11, 12.

8. Driverless: Through the IoT sensing, communication technology, intelligent traffic regulation and control, fully automatic intelligent control, drive Shuttle real-time response to this Shuttle and other Shuttles conditions triggered by a variety of operating commands, to achieve Shuttle driverless, moving, stopping, parking and emergency response, and can make the baggage Shuttle or/and the companion Passenger Shuttle accompany and arrive simultaneously. Solve the technical problems No. 1, 5, 11, 13, 16, 17, 18, 20, 22, 24 and the new features No. 2, 7, 8, 12.

9. De-consolidation Transport: By eliminating centralized terminus, eliminating the transport mode of consolidation, and combining shuttle and one-stop arrival technical solutions, eliminate passenger-dense public spaces, cut the causal chain of public health and public safety incidents, resulting in zero accidents and increased privacy. Solve the technical problems No. 1, 2, 4, 7, 14, 15, 16, 18, 24.

10. System-wide Intelligent Monitoring: Using shuttle monitoring, road network monitoring, road condition diagnosis and other measures to carry out real-time monitoring, analysis, pre-judgement of road and vehicle conditions, real-time response, optimization of routes, automatic scheduling, automatic billing and charging and other operations, optimizing and temporarily responding to Shuttle routes in advance, and implementing multiple error-proofing measures. Solve the technical problems No. 1, 6, 13, 16, 17, 19, 20, 21, 24 and the new function No. 8, 10.

11. Standard Modules: Modularizing standard modules such as Pipeline, Shuttle, interchanges, maintenance, etc., and easily splicing these modules to connect road sections, areas, cities, intercity, countries and regions without boundaries. Solve the technical problems No. 1, 8, 16, 18, 24.

12. Seamless Connection: Inserting the road network and stations/stops in a Specific Area or any area where they can be inserted to implement a multi-industry integration of shuttles, transportation, and services, and to form an all-in-one service, without the need to be first transported to the merchant's warehouse, sold, licensed, transferred, etc., the Shuttles will be online as soon as they leave the factory, and the passengers can take the Shuttle nearby. Solve the technical problems No. 1, 2, 3, 4, 7, 10, 14, 15, 16, 23, 24 and the new function No. 1, 2, 4.

13. Unlimited Speed: Under the premise of safety and design permission, the Intelligent Control System according to the road condition automatically adjusts the speed without speed limit, automatically selects the high speed first and as fast as possible to minimize the time in transit. Solve the technical problems No. 1, 3, 4, 6, 11, 16, 18, 20, 24 and the new function No. 1.

14. Online Driving and Online Parking: Online driving when busy and online parking when idle, realizing that the Shuttle is not offline, instant responding to switching the driving and parking status, maximizing the use of pipeline space, and eliminating ground parking spaces. Solve the technical problems No. 1, 4, 10, 12, 16, 21, 24 and the new functions No. 5.

15. Electricity Energy: Distribution of power stations and laying of lines along the pipeline to provide electricity energy for STS and its continuous cleanliness. Solve the technical problems No. 9, 24.

16. MLMD: The magnetic poles are installed in the Shuttle and the pipe respectively, which cooperate with each other to form Magnetic Levitation, Magnetic Driving and Magnetic Braking (or MB) to obtain good controllability and reliability. Solve the technical problems No. 1, 9, 11, 16, 22, 24.

17. Reduction of Accident Causal Chains: By changing the component elements of the vehicle and traffic system, and by using reorganization of elements of enclosed Pipeline, Shuttle separation, quasi-single person ride, driverless, de-visualized signal, hidden danger warning, intelligent IoT, Joint Intelligent Control, etc., to minimize the causes of accidents and break the accident causal chains. Solve the technical problems No. 1, 5, 6, 7, 8, 9, 10, 11, 12, 13, 14. 16, 17, 18, 22, 24.

18. Health Monitoring and Health Emergency: The Shuttle is equipped with health monitoring devices, with health emergency help function, automatically monitor passenger health signs in transit, and when passengers are found to have abnormal health, immediately open the emergency channel to accelerate direct access to the appropriate hospital, and synchronize the notification of the hospital emergency center and his guardian, and forcibly connect the guardian's phone in emergency case, also in the case of non-emergency medical treatment, passengers can choose the priority of medical treatment. Solve the technical problem No. 20 and the new feature No. 1, 2, 6, 7, 9, 11, 24.

19. Transport P/C: Granting different P/C levels to persons with special needs, such as military personnel, police officers, medical personnel, patients, students, public officials, etc., to ensure that they travel first and are transported quickly. Solve the technical problem No. 20, 24 and the new feature No. 1.

20. Special Control System: Using special measures such as remote automatic locking and tracking, locking of doors, forced change of destination, etc., to control and deliver specific persons when necessary. Solve the technical problem No. 24 and the new functions No. 2, 9.

21. Big Data: Automatically complete the identification, collection, statistics and analysis of data such as identification, trace search, travel data, Shuttle distribution, personnel distribution, Shuttle utilization, STS status, passenger status and habits, etc., and push convenient services such as travel density and other information, best travel time suggestions and ride reservations for travelers in real time and optimize STS. Solve the technical problem No. 1, 6, 15, 19, 20, 24 and the new function No. 1, 2, 3, 5, 8, 9, 10, 11, 12.

22. Exclusive Delivery and Sharing: Replace the vast majority of vehicles carrying people and cargos with Shuttles, share them for private rides or shipments, dedicated delivery direct, so that passengers are not affected by others and choose independently in terms of travel time, routes, moving and parking, habits, sightseeing, entertainment, sitting and sleeping, rest, health, privacy, independent carpooling, etc., and reduce the disadvantages of carpooling stagnation, large distribution and delivery, difficulty in direct access or too high cost of direct access. Solve the technical problem No. 1, 2, 4, 14, 15, 18, 20, 24 and the new feature No. 4.

23. Automatic Fire Recognition and Response: locking the location of the fire, clearing the nearby Shuttles, activating the automatic sprinklers in the pipeline, instantly targeting the fire, activating the fire alarms and other fire contingency plans, and equipping the pipeline and Shuttles with fire-fighting equipment. Solve the technical problem No. 1, 6, 24 and the new function No. 6, 10.

24. Non-fixed Emergency Channel: In case of emergency, a section of lane or/and a route will be cleared automatically and become an emergency lane in a second, realizing unobstructed super-high-speed access. Solve the technical problem No. 1, 6, 20, 24 and the new function No. 1, 7.

25. Error-proofing: Using various Error-proofing measures such as Separation Pipeline, Shuttle collision avoidance, etc. Solve the technical problem No. 1, 10, 12, 16, 17, 24 and the new function No. 8.

26. Warning Alerts: Real-time monitoring of whether the passenger's seat belt is buckled before and during the movement of the shuttle, prohibiting the opening of the seat belt at medium and high speeds, or voice reminder or warning when it is opened, or even remotely intervening to force the shuttle to stop in the vicinity. Solve the new function No. 9.

27. Pre-judgment of Unobstructed Path: The monitoring system automatically determines the road conditions and provides driving commands for the Shuttle that is about to travel through. Solve the technical problem No. 1, 3, 6, 24 and the new function No. 7, 10.

28. Cloud Payment: No ticket or card purchase and payment process, automatic billing and settlement. Solve the technical problem No. 1, 6, 24 and the new function No. 12.

29. At the same time of using the above technical solutions, along with the elimination of traffic police duty, driver training, vehicle inspection and control, toll facilities, repair stores, gas stations, car wash and decoration services, parking lots and many other related services, greatly saving resources and reducing pollution. Solve the technical problems No. 1, 9, 24.

### BENEFICIAL EFFECTS

### Beneficial Effects at the Level of Solving Conventional Technical Problems

1. In terms of traffic pressure capacity: The problem of insufficient capacity and difficulty in riding in the morning and evening peaks (accounting for about 80% of the whole day's passenger traffic) is effectively solved, and the peak bottleneck is cracked to achieve high traffic volume and super high-speed transportation of passengers and cargos. In addition to special vehicles and bulky (beyond the Shuttle loading size or weight) trucks, the Shuttle can replace the vast majority of conventional vehicles, significantly reducing the type of vehicles, the number and comprehensive resource consumption, eliminating the current problem of too many vehicles and excessive traffic pressure.

2. In terms of problem-solving aspect: Almost all the problems related to 2TS and vehicles are solved. For example, waiting for scheduled departures, crowded rides, traffic congestion, Pedestrian-Vehicle Mixed-Traffic, accident-prone, signal waiting, Manual Driving Risks, parking difficulties, weather effects, long in-transit time, en route transfers, ineffective accompanying rides, and high energy consumption, high pollution, high cost, low capacity, public health and public safety hazards, many vehicles, and resource waste, etc. The vicious circle of conventional vehicles and 2TS is eliminated from the macro and root causes.

3. Achieved “3+N” (i.e., 3 full, N zero): All day, all weathers, fully automatic, zero signals, zero signs, zero labor, zero drivers, zero accidents, zero fatalities, zero traffic police, zero traffic control, zero queues, zero waiting, zero terminals, zero tickets, zero paying action, zero congestion, zero stops, zero transfers, zero escorts, zero invalid time, zero violations, zero parking spaces, zero vehicles purchases, zero garages, zero training, zero interference, zero pollution, zero emissions, zero waste. (Zero here means true zero or approach zero).

4. In terms of efficiency: Compared with passenger vehicles, the Shuttle's speed is 2-10 times higher, transportation capacity is 2-10 times higher, and travel time is saved by about 80%.

5. In terms of Shuttle manufacturing and road construction: Because the Shuttle is much simpler than the conventional vehicle structure, so the manufacturing process will be greatly reduced, energy consumption is greatly reduced, the amount of raw materials is reduced, the process is more simplified, processing is easier, and efficiency is greatly improved, the cost of the Shuttle is reduced by about 80%; At the same time, because the Shuttle is miniature and lightweight, and magnetic levitation surface is large, the pressure of the Shuttle on a unit area of passageway is much less than the pressure of a four-wheeled car on a road, so the construction and maintenance costs of the Pipe-Tunnel System will be significantly reduced, the cost of pipeline is reduced by about 80%, the construction cycle is shorter, and the life of the Pipe-Tunnel System is longer.

6. In terms of Shuttle use and operation: Tell the Shuttle where to go, and no other operation.

7. In terms of time efficiency: The Intelligent Control System automatically controls the entire STS, eliminating the Manual Driving Risks, breaking the conventional speed bottleneck, realizing the global scope, all day, all-weather, unlimited speed driving, unattended, driverless, optimized path, non-stop, non-blocked, private special delivery, One-Stop Arrival, minimizing the time cost, invalid time approach zero.

8. In terms of parking: The dual function of Online Driving and Online Parking is realized, which eliminates the parking problem and saves comprehensive resources.

9. In terms of risk of accidents: It breaks the routine of risk control methods with low reliability that lacked traffic safety and error-proofing measures and relied mainly on human security and regulatory constraints etc., since the beginning of motor vehicles. And eliminates most of the causes of accidents, breaks the more accident causal chains, making the risk approach zero, accidents approach zero and casualties approach zero. Even in the event of a collision, it will not burn or explode.

10. In terms of safety and reliability: It realizes fully automatic intelligent control, driverless, real-time self-diagnosis and self-correction and self-balancing, which improves the reliability, safety, efficiency, accuracy and prediction of the whole system.

11. In terms of public events: Fundamentally eliminates the existing public places and consolidation transport mode, making travel safer, sanitary and private. Both save resources and eliminate the public health events (such as COVID-19 dense infection) outbreak, difficult to control or out of control, epidemiological investigation, disinfection and control can be done instantly and automatically; at the same time, it also eliminates the occurrence of public safety events approach zero.

12. In terms of vehicle and traffic globalization: Leading the standardization and interoperability of global road networks and Shuttles, breaking the practice of differentiation between urban and intercity and international traffic vehicles, and realizing nationwide and even global common use and access.

13. In terms of resources and environmental protection: used high-efficiency, zero-emission electricity energy, significantly reducing or even eradicating the resource waste and environmental pollution in various links related to fuel, vehicles and roads; Greatly reduce the cost of road construction, reduce the road construction cycle and reduce pollution, abate the vehicle manufacturing process links and processing cycle, significantly reduce the pollution and vehicle manufacturing-related energy-consuming industrial chain, such as rubber manufacturing, tire manufacturing, smelting, casting, machining, glass manufacturing, paint manufacturing and spraying, maintenance, etc., resources and the environment will be sustainable protection. Energy savings of about 80%, lane width reductions of more than 30%, lane height reductions of more than 60%, and offline parking spaces zeroed out.

### Beneficial Effects at the Added Functional Level:

1. To provide more services of P/C for military, police, students, doctors, confidential, postal and other related personnel or cargos.
2. To make access to Specific Areas more convenient, safer, and not limited by time and space, and to achieve a greater range of seamless connection and One-Stop Arrival.
3. Put out fires and reduce casualties and losses in a timely manner.
4. Minimize the time between the onset of illness and the administration of help to buy more life-saving time for the patient.
5. Cut off the Accident causal chains, especially serious accidents are highly unlikely to occur.
6. Timely detection and termination of passenger behavior that poses a threat to life or the traffic system.
7. Optimize Shuttle routes to ensure the shortest time duration for different routes.
8. Easily collect, analyze and process all kinds of traffic big data, carbon emission contribution data, etc.; increase the initiative, optionality and convenience of traveling by Shuttle; moreover, through big data analysis, optimization and prediction capabilities, we can obtain the decision basis of how to optimize traffic distribution, city planning, industry construction, national policies, and even national development strategies.
9. No ticket no-actions cloud payment, so that travel is greatly convenient, more resource-saving, reduce waste and pollution.

### Beneficial Effects at the Level of User Experience and Consumer Awareness:

1. Changing transportation consumption habits, travel patterns and cultivating green consciousness, all trips will become faster, more private, comfortable, fun, economical and green, and will make people more willing to give up their high consumption, high pollution and low efficiency private vehicles and take Shuttles instead, advocating green travel.

2. Compared with the conventional vehicles or private car, taking STS is “spending bus fare, taking driverless Shuttle”, which is economical, fast, comfortable, not fatigue, and protects privacy, but no longer worry about buying, refueling, charging, maintenance, inspection, parking space, parking, care, etc., not to worry about travel safety.

3. All day all-weather travel, unlimited speed, no congestion, no stopping en route, no accompanying, no transfer, no waiting, cloud payment, shorten the travel time by about 80%, the whole process of sitting and resting, entertainment, office at will. Safe, convenient, high-speed, direct access. Let people get the relaxation, pleasure and satisfaction of “taking the Shuttle, arriving in a while”.

### Economic Benefits:

1. The STS unmanned operation and control has enabled significant savings in labor costs.

2. STS alone can reduce to a great extent: The length of time in transit, invalid time, drivers, police, road personnel, parking space occupation, road occupation, driver training, vehicle ownership, vehicle management, vehicle industry chain links, fuel-related links, traffic accidents and loss of life and property, resource waste, etc. The economic benefits generated by the savings alone are incalculable.

For example, a city's average morning peak congestion duration in 2018 was 2 hours and 50 minutes, the city's total annual weekday motor vehicle trips totaled 22.84 million, the peak passenger trips accounted for 42.6 percent of all day passenger trips, the evening peak accounted for 35.4 percent of all day trips, and the city's average annual wage for employed persons was RMB94,258 yuan. Implementation of STS, calculated for the city only, for the morning and evening peaks only, for motor vehicles only, and for the congestion time item in the ineffective time only, translates into a time cost of RMB2,252.7 million yuan in lost revenue in 2018.

3. Industries related to vehicles and STS can significantly reduce the cycle and cost of construction and operation and maintenance of the road network and its supporting facilities, significantly reduce the service supporting functions and expenditure, significantly shorten the multi-industry chain, including vehicles, simplify the manufacturing process, eliminate the vehicle operation and maintenance links, eliminate fuel processing storage and transportation links, significantly reduce the negative impact on the environment and environmental management investment, etc. At the same time, with the significant increase in operational efficiency, the vehicle and STS-related industries to support the economic development provided and pull up, the value of both open-source and cost-saving is too large to estimate. The new business format of transportation formed by STS also brings huge economic benefits to the global economy.

### Social Benefits:

1. Construct the future of vehicles and transportation: The invention herein constructs a new system model and standard framework of Shuttle transportation for future human beings, providing the most effective, fastest, lowest cost, safest and most environmentally friendly transportation guarantee for human economic activities. At the same time, statistical traffic information will be more comprehensive and precise. This will also be the new mode and development direction of land transportation in the future.

2. New Business Format: The invention herein is based on IICB, and integrates the shuttle with road network, service, urban planning and other multi-industrial integration, defines and innovates and invents an IoT-based Transportation Shuttle and Shuttle Traffic System, which is a new business format and new concept of transportation for global green travel and green consumption. Shuttle and STS will be the future leader and maker of the world's transportation rules, which can provide technical and economic support for the whole world. It will solve the world's transportation problems and create immeasurable value for the transportation and economic development of all countries in the world.

3. Global sharing: The invention herein belongs to the future transportation equipment of mankind and its supporting traffic system infrastructure, It can be implemented globally, opening up the transportation veins between countries and realizing a new future transportation order of global unity, resource sharing and global access, which will in turn bring great benefits to all mankind.

4. Green Revolution and Sustainable Transportation: Firstly, it drastically removes conventional vehicles and 2TS-related signals, road signs, parking spaces, road administration, petrol stations, crude fuel extraction, fuel manufacturing, storage and transportation, patrolling traffic police, maintenance points, driver training, etc., which reduces the resource waste, environmental pollution and safety risks, and improves the living environment of human beings. At the same time, through the greater popularization and use of Shuttle and clean energy, to cultivate people's transportation habits of green travel, green consumption. Ultimately, Shuttle transportation will play an important role as part of the community of human destiny for the realization of the concept of sustainable development of human beings, which is low carbon and environmental protection and resource sharing.

5. Shuttle Effect: Due to creating Shuttle and Shuttle Traffic is so involved in a wide range, such as in the global scope, its own can reduce resource extraction, processing, transportation, consumption, and reduce other pollution from industries that process, manufacture, and transport products related to a variety of vehicle, which will inevitably lead to the transportation related to many high-pollution, high-energy, high-resource-input industries, enterprises, or processes to carry out a large-scale green revolution, thus, which will trigger a series of cross-industry, multi-industrial, multi-directional global green action, resulting in a chain reaction, the formation of the shuttle effect, and to promote a huge transformation of the various industries, all levels, and various aspects.

For example, just one item of fuel for 14,354,800 road-operated vehicles and 205,749,300 private vehicles for one country at the end of 2018, and based on the average fuel consumption of 6 liters per vehicle per 100 kilometers, if the Shuttle replaces 70% of the existing vehicles, it will reduce fuel usage by about 277,324 million liters, reduce carbon dioxide emissions by about 558, 126 million kilograms, and reduce heat emissions by about 8,538,934,544 million kilojoules per year. Together with the fuel-related industries all reducing the corresponding amount of output to achieve zero emissions, its social value and significance is self-evident. Only the Shuttle itself to electricity energy instead of fuel one, will pull the world at the same time, in advance of the carbon peak, carbon neutral goal.

### BRIEF DESCRIPTION OF THE DRAWINGS

1. Co-Description of FIG. 1, FIG. 2, and FIG. 3:

FIG. 1, FIG. 2, and FIG. 3 represent only schematic diagrams of the major components included in the STS system and the logical relationships required to realize the functions, and do not represent compositional details or location relations.

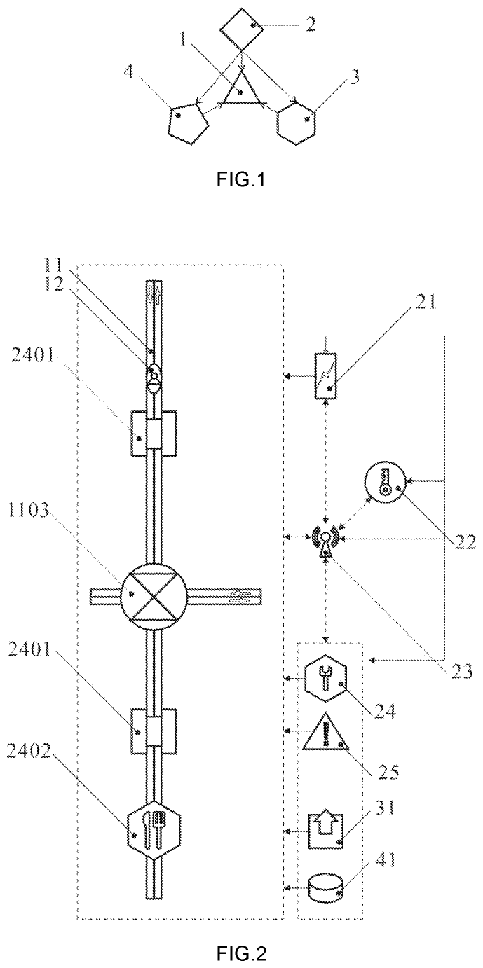

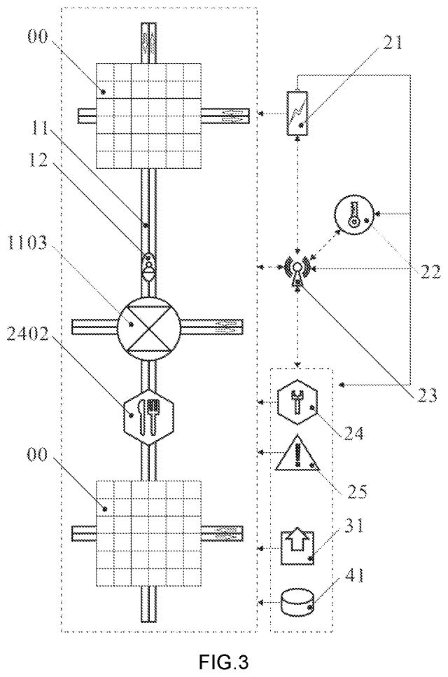

In FIG. 1, FIG. 2, and FIG. 3, solid one-way arrows indicate a support relationship, with the arrows pointing to supported objects; dashed two-way arrows indicate a communication relationship, with one end of the arrows pointing to the Communication System body, the other end of the arrows pointing to objects that need to be communicated with, if the other end of the arrow pointing to the dashed box, all the objects in the box are communication objects.

The numerical numbers in FIG. 1, FIG. 2, and FIG. 3 (except for 00 in FIG. 3) correspond to the numbers and what they represent in Table 1 below, and the numerical numbers represent the major components of STS.

Note: The numerical number 00 in FIG. 3 is just a temporary code for the regional STS, which may cover a larger or smaller area and is a nested composite of the composition shown in FIG. 2. A regional STS can be a Section STS, a District STS, a City STS, an Intercity STS, or a National STS.

2. FIG. 1 Description: FIG. 1 shows a schematic diagram of the logical relationship of STS macroscopic composition and each STS Parent System. In FIG. 1, 1 Shuttle-tunnel System, 2 Control-Safeguard System, 3 Emergency Response System, and 4 Data System. FIG. 1 shows the macroscopic composition of STS.

3. FIG. 2 Description: FIG. 2 shows a schematic diagram of the logical relationship of the basic STS components, the major STS Child Systems and the major STS Grandchild Systems. In FIG. 2, 11 Pipe-Tunnel System, 12 Shuttle System, 2401 Station Service System, 1103 interchange system, 2402 Intercity Service System, 21 Energy System, 22 Intelligent Control System, 23 Communication System, 24 Service System, 25 Safety System, 31 emergency system, 41 Data System. FIG. 2 shows the smallest unit of STS.

4. FIG. 3 Description: FIG. 3 shows a schematic diagram of the logical relationship of the intercity or international composition of STS, the major STS Child Systems and the major STS Grandchild Systems. In FIG. 3, 00 regional STS, 11 Pipe-Tunnel System, 12 Shuttle System, 1103 interchange system, 2402 Intercity Service System, 21 Energy System, 22 Intelligent Control System, 23 Communication System, 24 Service System, 25 Safety System, 31 emergency system, 41 Data System. FIG. 3 shows the nested combination of the minimum units formed by FIG. 2 to form the regional STS, and the logical relationships of the different regional STS.

### DETAILED DESCRIPTION OF THE INVENTION

The best implementation of the invention herein is: A Passenger Shuttle load of 1+1 persons, globally harmonized standard modules, design speed upper threshold as high as possible, as many stations/stops as possible and inserted them in Specific Areas. Specifically, as follows:

1. The composition and numbering of the STS framework, Parent Systems, Child Systems and Grandchild Systems, which is shown in Table 1 below:

TABLE 1

| | Parent | Child | |
|---|---|---|---|
| Framework | System | System | Grandchild System |
| Hard Body | Shuttle- | Pipe-Tunnel | Pipeline System 1101, Magnetic-Road |
| | Tunnel | System 11 | System 1102, Interchange System 1103, |
| | System 1 | | Station System 1104, Pipeline Sensing |
| | | | System 1105, Cabling System 1106, |
| | | | Escape Route System 1107 |
| | | Shuttle | Shuttle Body System 1201, Leviation- |
| | | System 12 | Driving System 1202, Standby Driving |
| | | | System 1203, In-Shuttle Positioning |
| | | | System 1204. Air Conditioning System |
| | | | 1205, Lighting System 1206, Audio- |
| | | | Visual Interaction System 1207, |
| | | | In-Shuttle Sensing System 1208, |
| | | | In-Shuttle Safety System 1209, |
| | | | Identification System 1210, In-Shuttle |
| | | | Communication System 1211, |
| | | | In-Shuttle Intelligent Control System |
| | | | 1212, Wiring Harness System 1213, |
| | | | Seat System 1214 |
| Soft | Control- | Energy System | Power Distribution System 2101, Energy |
| Combination | Safeguard | 21 | Saving System 2102 |
| | System 2 | Intelligent | Intelligent Central System 2201, Manual |
| | | Control System | Control System 2202, Human-Computer |
| | | 22 | Interaction System 2203, User Control |
| | | | System 2205 |
| | | Communication | Intelligent Control Communication |
| | | System 23 | System 2301, Information Communication |
| | | | System 23202 |
| | | Service System | Station Service System 2401, Intercity |
| | | 24 | Service System 2402, Inspection-Repair |
| | | | System 2403, Operation-Maintenance |
| | | | System 2404, Parking System 2405, |
| | | | Cleaning System 2406, Shuttle APP 2407 |
| | | Safety System | Cause Monitoring System 2501, Personal |
| | | 25 | Protection System 2502, Health Monitoring |
| | | | Trigger System 2503 |
| | Emergency | Emergency | Health Emergency Response System |
| | Response | Response | 3101, Accident Emergency Response |
| | System 3 | System 31 | System 3102, Fire Emergency Response |
| | | | System 3103 |
| | Data | Data | Data Collection System 4101, Data |
| | System 4 | System 11 | Analysis System 4102, Data Storage |
| | | | System 4103 |

2. In Table 1, the STS framework and functional realization:

Hard Body, which is mainly represented by the hardware required for protection and transportation, is the main part of the STS transportation function. One of the main functions: guarding Shuttle and Soft Combination, which is realized by Pipeline System 1101; the second of the main functions: automatic transporting passengers and cargo, which is realized by Shuttle System 12.

Soft Combination, which is mainly represented by the software and services required for control and service, is the peripheral part that guarantees the automatic operation of the transport body of STS. One of the main functions: Controlling the automatic operation of Shuttles and the communication links and data acquisition among the various components, which is jointly accomplished by Intelligent Control System 22, Communication System 23, and Data System 41; The second of the main functions: Providing support services such as energy, security, emergency and service for entire STS, which is accomplished by Energy System 21, Safety System 25, Emergency Response System 31, and Service System 24.

3. In Table 1, Composition and functional realization of Parent System of STS:

Shuttle-tunnel System 1, which provides the framework for all the facilities of the road network and carries passengers and cargos.

Control-Safeguard System 2, which controls and guarantees the automatic operation of all systems.

Emergency Response System 3, when abnormal, to deal with various emergency events.

Data System 4, which processes all data information, and the data is used by Control-Safeguard System 2.

4. In FIG. 1, The operational logic relationships among the Parent Systems:

In FIG. 1, The Shuttle traffic is divided into two major parts. First, Shuttle-tunnel System 1 constitutes the transport body of STS. Second, Control-Safeguard System 2, Emergency Response System 3 and Data System 4 constitute the STS intelligent control linkage, the intelligent control linkage plays a supporting and guarantee role for STS.

When normal, In FIG. 1, Control-Safeguard System 2 automatically controls Shuttle-tunnel System 1 and Data System 4 to complete the coordinated operation of the three major Parent Systems, the three are in interactive feedback, correction, command, response, correction and storage mode.

When abnormal, In FIG. 1, Emergency Response System 3 is activated, and Control-Safeguard System 2 automatically controls the coordinated operation of the four major Parent Systems of Shuttle-tunnel System 1, Emergency Response System 3 and Data System 4, the four are in interactive feedback, correction, command, response, correction and storage mode.

5. In Table 1, Composition and functional realization of each Child System of STS:

Pipe-Tunnel System 11, which provides space for Shuttle System 12 to travel, provides space for other systems to lay out hardware.

Shuttle System 12, which travels in Pipe-Tunnel System 11, transports passengers or cargos.

Energy System 21, which provides energy for the entire STS.

Intelligent Control System 22, which sends commands and coordinates the operation of the various parts of STS through Communication System 23.

Communication System 23, a communication hub among Intelligent Control System 22 and the various parts of STS, provides applications for human-human dialog and human-machine dialog.

Service System 24, which provides related services for Pipe-Tunnel System 11, Shuttle System 12, and passengers.

Safety System 25, which provides safety measures and security for Pipe-Tunnel System 11, Shuttle System 12, and passengers.

Emergency Response System 31, which provides emergency response to Pipe-Tunnel System 11, Shuttle System 12, and passengers in the case of an emergency.

Data System 41, through Communication System 23, process the data of the whole system, and the data serves as the basis for the commands and coordination of Intelligent Control System 22.

6. In FIG. 2, The operational logic relationships among the major Child Systems and some of the Grandchild Systems:

In FIG. 2, The smallest unit of STS operating independently from which a regional STS may be constituted.

In the large dashed box on the left side of FIG. 2, the main systems such as Pipe-Tunnel System 11, Shuttle System 12, Station Service System 2401, Interchange System 1103 (when there is an intersection), and Intercity Service System 2402 (when there is an intercity Pipeline) constitute Shuttle-tunnel System 1 in FIG. 1, which is the smallest module of STS operation. Among them, Pipe-Tunnel System 11 provides space for the travel passageway and route of Shuttle System 12, and for other hardware deployed along the route. Shuttle System 12 is the transport equipment for carrying passengers or cargos, Station Service System 2401 is distributed at the appropriate locations of Pipe-Tunnel System 11, Interchange System 1103 is laid out at all intersections, and Intercity Service System 2402 is distributed in the intercity section of Pipe-Tunnel System 11.

On the right side of the large dashed box in FIG. 2, the main systems such as Energy System 21, Intelligent Control System 22, Communication System 23, Service System 24, and Safety System 25 constitute Control-Safeguard System 2 in FIG. 1. Among them, Energy System 21 provides electricity energy support for all systems, Intelligent Control System 22 is the control center of all systems, Communication System 23 is the communication hub among systems, Intelligent Control System 22 communicates commands and data with each of the other systems and controls them through Communication System 23, Service System 24 provides a variety of standing and temporary service guarantees for the system, and Safety System 25 provides safeguards for reducing various security events.

On the lower side of the small dashed box on the right side of FIG. 2, Emergency Response System 31 forms Emergency Response System 3 in FIG. 1. Emergency Response System 31 handles all types of emergencies.

On the lower side of the small dashed box on the right side of FIG. 2, Data System 41 forms Data System 4 in FIG. 1. Data System 41 handles all data information, including acquisition, analysis, and storage.

7. In Table 1, Composition, location relations and functional realization of each Grandchild System:

7.1. In Pipe-Tunnel System 11, Composition, location relations and functional realization of each Grandchild System:

Pipeline system 1101, which separates the moving Shuttle from everything outside the pipe, provides deployment space and protection for Shuttle System 12, Magnetic-Road System 1102, Interchange System 1103, Station System 1104, Pipeline Sensing System 1105, Cabling System 1106, Escape Route System 1107, etc.

Magnetic-Road System 1102, which provides a travel passageway for the Shuttle, and acts in conjunction with Levitation-Driving System 1202 to form a magnetic levitation force and a magnetic driving force to hold up, drive and break the Shuttle.

Interchange System 1103, which is located over all intersections in Pipeline System 1101, eliminates the need for stopping at intersections.

Station System 1104, which is located at appropriate locations in Pipeline System 1101, provides space for Shuttle stopping, passengers getting on and off, or loading and unloading of cargos.

Pipeline Sensing System 1105, which is located at appropriate locations in Pipeline System 1101, senses information such as road conditions, vehicle conditions, vehicle speed, vehicle position, route, and the like, alone or in conjunction with In-Shuttle Sensing System 1208.

Cabling System 1106, which is laid in Pipeline System 1101, contains the lines of energy, communication, intelligent control, etc., to transmit power, data, commands, and the like, respectively.

Escape Route System 1107, which is separated from the traveling passageway, is used for the escape or access of relevant personnel, such as emergency escape, inspection and maintenance, and accident handling, etc.

7.2. In Shuttle System 12, Composition, location relations and functional realization of each Grandchild System:

Shuttle Body System 1201, which provides layout space for the other Grandchild Systems of Shuttle System 12 and passengers or cargos, including door and escape port, etc. It presents a shape that is more conducive to reducing wind resistance, and Passenger Shuttles and Cargo Shuttles are miniaturized (Passenger shuttle load not exceeding 4 persons and optimized for 1+1 persons, with the possibility of exclusive rides alone and voluntary carpooling or putting luggage in to minimize empty loads; cargo shuttle limited loads), lightweight, intelligent, MLMD, and driverless. The shuttle state information obtained by its In-Shuttle Sensing System 1208 and Pipeline Sensing System 1105, through In-Shuttle Communication System 1211 and Communication System 23, which is intelligently interacted with Intelligent Control System 22, immediately Intelligent Control System 22 makes all kinds of commands, these commands act on the Shuttle and other systems to make them present different states, in order to complete the functions of passenger getting on and off or cargo loading and unloading, driving, optimizing route, braking, parking, etc., and realize One-Stop Arrival.

Levitation-Driving System 1202 and Magnetic-Road System 1102 interact with each other to realize the Shuttle's MLMD and MB functions, and complete the actions of levitation, traveling (i.e., forward, backward, lane-changing) and stopping.

Standby Driving System 1203, provides the Shuttle System 12 with a backup driving to be used for a short period of time in case of repair or emergency.

In-Shuttle Positioning System 1204, together with In-Shuttle Sensing System 1208 and Pipeline Sensing System 1105, determines the precise position of the Shuttle and transmits it to Intelligent Control System 22; the distance information between the front and rear of the vehicle sensed by In-Shuttle Positioning System 1204 and Pipeline Sensing System 1105, and the relevant information of Safety System 25, which are transmitted to Intelligent Control System 22 via In-Shuttle Communication System 1211 and Communication System 23. The above information is analyzed comprehensively by Intelligent Control System 22, to provide the Shuttle with collision avoidance measures (e.g., acceleration and deceleration, braking, and stopping, etc.).

Air Conditioning System 1205, Lighting System 1206, respectively, realize the functions of regulating the temperature, oxygen content, lighting in Shuttle.

Audio-Visual Interaction System 1207, which provides passengers with Individual and interactive entertainment audio-visuals and realizes human-machine dialog with Intelligent Control System 22, or communicates with STS staff, medical personnel, friends, guardians, etc.

In-Shuttle Sensing System 1208, which contains sensing items for positioning, ranging, collision avoidance, health, etc., senses the Shuttle's operating status and position, environmental data in Shuttle, the passenger's situation and other information, and combines with Pipeline Sensing System 1105 to complete the Shuttle's comprehensive sensing data, through In-Shuttle Communication System 1211 and Communication System 23, which is fed to Intelligent Control System 22 for corresponding processing.

In-Shuttle Safety System 1209, which contains sensing devices, alarm devices, airbags, seat belts and fire extinguishers to provide sensing, alarming and protection for safety in the Shuttle.

Identification System 1210, which is used to sense the identity of the passenger or the cargo and compare it with the big data information in the library of Data System 41, is used for Intelligent Control System 22 to make the corresponding disposition commands (e.g., whether it is suitable for the ride, push the normal route, friendly reminder, special attention, lock the trajectory, lock the end point, etc.).

In-Shuttle Communication System 1211, which is located within the Shuttle, has communication channels in the form of wired and wireless. It transmits various information or needs originating from the Pipe-Tunnel System 11, Shuttle System 12, Health Monitoring Trigger System 2503, In-Shuttle Safety System 1209 and the passengers to In-Shuttle Intelligent Control System 1212 or/and Intelligent Control System 22 via the communication channels and, if necessary, to the relevant processing terminals, institutions or individuals.

In-Shuttle Intelligent Control System 1212, which is the on-board part of Intelligent Control System 22, is the execution end and information return end of Intelligent Control System 22 inside the Shuttle, and the passenger or receivers/shippers can give the corresponding need or instruction information to the Shuttle.

Wiring Harness System 1213, which is wired between shells and interiors of Shuttle Body System 1201, provides wired signal communication or electricity energy transmission to the various Grandchild Systems of Shuttle System 12.

Seat System 1214, which is mounted on the frame structure of Shuttle Body System 1201, can be seated or reclined.

7.3. In Energy System 21, Composition, location relations and functional realization of each Grandchild System:

Power Distribution System 2101, which is located throughout Pipe-Tunnel System 11, Intelligent Control System 22, Communication System 23, Service System 24, Safety System 25, Emergency Response System 31 and Data System 41, and distributes electricity for them.

Energy Saving System 2102, which is located in Pipeline System 1101 and/or Shuttle Body System 1201, works in concert with Intelligent Control System 22 to recover and utilize the energy generated by the high-speed moving Shuttles.

7.4. In Intelligent Control System 22, Composition, location relations and functional realization of each Grandchild System:

Intelligent Central System 2201, as the control center of the fully automatic operation of the whole system of STS, with the help of different functional modules, which uses the IoT operation mechanism to exchange information with various other systems through Communication System 23, and carries out operation control and intelligent processing of the Shuttle and other systems, realizing various fully-automatic intelligent control mechanisms including driverless and One-Stop Arrival.

Manual Control System 2202, which is used for manual control of a Shuttle or a section or an area during activities such as installation and commissioning, overhaul, maintenance, cleaning, emergency response, etc., can be switched with Intelligent Central System 2201.

Human-Computer Interaction System 2203, which provides the necessary freedom of choice for passenger, i.e., through a human-machine dialog between the passenger and Intelligent Central System 2201, allowing the latter to determine whether the information is feasible and issue commands to meet the passenger's reasonable needs (e.g., switching endpoints, entering service areas, calling, etc.).

User Control System 2204, which is a temporary limited control that allows passengers to operate the Shuttle autonomously in case of emergency.

Special Control System 2205, in special situations (e.g., first aid, rushing to an examination, suspects riding in a Shuttle, military needs, etc.), which allows for manual intervention to initiate, or automatic judgment by Intelligent Control System 22 to initiate, certain special operations in order to ensure that the necessary special results are obtained.

7.5. In Communication System 23, Composition, location relations and functional realization of each Grandchild System:

Intelligent Control Communication System 2301, which is the link among Intelligent Control System 22 and other Child Systems and Grandchild Systems for automatic communication through the IoT, is controlled by Intelligent Control System 22 and receive and analyze information, and then issue the corresponding commands.

Information Communication System 2302, which is located at various points of STS, contains communication exchanges for civilian, police, military, etc., and does not involve commands for controlling the operation of the Shuttle.

7.6. In Service System 24, Composition, location relations and functional realization of each Grandchild System:

Station Service System 2401, which is deployed in Pipeline System 1101, contains identification, destination statistics, station/stop guidance, temporary rest, timing of getting on and off, automatic fare deduction, etc. The stations/stops layout location can be a conventional layout way of public transport station/stop/terminal/airport/wharf, or also be a Specific Area. It contains hardware and services.

Intercity Service System 2402, which is service area and related services laid out for the intercity section of Pipeline System 1101.

Inspection-Repair System 2403, which is a timed inspection and repair service for the entire STS system.

Operation-Maintenance System 2404, which is the assurance system for STS operations, is a routine system maintenance task.

Parking System 2405, which contains the different functional passageways involved in Pipeline System 1101, controls online parking in close proximity at different times. It may include pipelines or areas dedicated to parking, or parking areas for Inspection-Repair System 2403.

Cleaning System 2406, which is a complete guarantee system for cleaning, decontamination and maintenance activities on the inside and outside of the Shuttle, Pipe-Tunnel System 11, etc., may also include the cleaning needs brought about by different weather.

Shuttle APP 2407, which is a client for passengers or consignors to obtain all kinds of travel information, book Shuttles, preset a destination, book a ride with a passenger or a carpool, participate in surveys, evaluate complaints, identify a guardian, and other services, facilitates improving the operation efficiency of Shuttle, and increases the goodwill of passengers and the affinity of the Shuttle.

7.7. In Safety System 25, Composition, location relations and functional realization of each Grandchild System:

Cause Monitoring System 2501, which is a combination of hardware and software for monitoring and controlling the causes that may lead to accidents in the STS system, and its monitoring data, via In-Shuttle Communication System 1211 and Communication System 23, is sent to Intelligent Control System 22 and Data System 41 for processing and making various disposal commands or information release such as accident prediction, warning, elimination, avoidance, and emergency response etc.

Personal Protection System 2502, which is a relevant measure and response mechanism for protection of personal safety set up in Pipe-Tunnel System 11, Shuttle System 12 and other systems, comprises In-Shuttle Safety System 1209.

Health Monitoring Trigger System 2503, which is a system that utilizes In-Shuttle Sensing System 1208 to monitor the passenger's health throughout the entire process, and after being automatically judged by the Intelligent Control System 22, activates Health Emergency Response System 3101. Alternatively, the passenger utilizes Human-Computer Interaction System 2203 to provide personal health information or medical needs to Intelligent Control System 22 to change the end of travel or to activate the system of Health Emergency Response System 3101.

7.8. In Emergency Response System 31, Composition, location relations and functional realization of each Grandchild System:

Health Emergency Response System 3101, in Shuttle Body System 1201, is used to monitor the main health indicators of the passenger, and after judgment by Intelligent Control System 22 automatically determines whether to directly reroute the passenger to a hospital or to give a recommendation for the passenger to make his or her own choice. And when there is an obvious abnormality in the vital signs, Intelligent Control System 22 automatically decides to activate the emergency plan to send the passenger to the appropriate hospital, and at the same time notify the hospital and the guardian. It consists of avoiding the emergency channel, accelerating to the hospital, calling the hospital, calling a guardian or friend, etc.

Accident Emergency Response System 3102, which is composed of accident sensing devices that located in Pipeline System 1101 and Shuttle System 1201, constitutes the hardware of the system, and the accident or abnormal signals sensed therein are transmitted to Intelligent Control System 22 through Communication System 23, or the passengers make a call through Human-Computer Interaction System 2203, triggering Intelligent Control System 22 to initiate an emergency response. It includes emergency stopping, escape, first aid, retreating from accident points and more.

Fire Emergency Response System 3103, When a fire occurs in Pipeline System 1101, Shuttle Body System 1201 or other hardware systems, Pipeline Sensing System 1105 and In-Shuttle Sensing System 1208 that are located on such hardware send a sensing signal to Intelligent Control System 22 to trigger the initiation of the fire emergency response, and/or sent to the passenger via Audio-Visual Interaction System 1207 to activate the fire emergency response. Fire emergency response includes automatic sprinkler activation in Pipeline System 1101 and small fire extinguisher activation inside the Shuttle, as well as emergency stops, escapes, and rescues, etc.

7.9. In Data System 41, Composition, location relations and functional realization of each Grandchild System:

Data Collection System 4101, by various types of sensors that are located in Pipeline System 1101, Shuttle Body System 1201, and other parts, which senses and collects various types of information data containing passenger identity, stations/stops, pipelines, passageways, energy, Shuttles, power levels, passenger flow, distribution, positioning, etc., and transmits the information to a data center of Data System 41 via In-Shuttle Communication System 1211 and Communication System 23.

Data Analysis System 4102, which performs comprehensive statistics and big data analysis on the above data, obtains data that facilitates a better passenger experience or obtains a decision basis for STS improvement. These analyzed data bases are used in Intelligent Control System 22 for resource allocation and balancing of the entire STS system, as well as for autonomous optimization and more effective control and expansion of Shuttles distribution and speed, or for pushing more valuable information to passengers, or for guiding engineers to improve the STS, etc.

Data Storage System 4103, which is placed in the cloud, provides storage space for the various data mentioned above for further analysis and recall.

7.10. In FIG. 3, the logical relationships among the major Child Systems and Grandchild Systems:

Inside the large dashed box in FIG. 3, it is a nested combination of the basic STS operating units shown in FIG. 2, to form a larger regional STS.

In FIG. 3, 00 is just a temporary code for the regional STS, as mentioned above.

The right part of the large dashed box in FIG. 3 is equivalent to the right part of the large dashed box in FIG. 2, and is placed here to visualize each of the major components and logical relationships of an Intercity STS or Global STS.

### BEST MODE FOR CARRYING OUT THE INVENTION

### Implementation Example 1, Implementation of Section STS

For example, Section STS between places A and B, 1 person (or 1+1 persons) will need to travel by the Shuttle:

Setting up a station/stop at each of places A and B (called A Station and B Station respectively. They include Station System 1104 and Station Service System 2401.), one passenger (who may also ride with one family member, friend, or carpooler) ride a Shuttle after entering the destination B at the terminal of A Station, or enter the destination on User Control System 2204 after getting on a Shuttle. After settling in Seat System 1214, the door of the Shuttle closes automatically, and Audio-Visual Interaction System 1207 reminds passenger to fasten seat belt. At the same time, Identification System 1210 in the Shuttle automatically confirms the passenger's identity and matches the permit with the destination to determine whether the P/C is available, and if NO, Intelligent Central System 2201 sets the route as a regular lane (regular lane is also the shortest time duration preferred lane), if YES (such as military or law enforcement officers, students, doctors, etc.), the route is set as a priority lane or licensed lane, and if the passenger does not have the right to enter the destination, the passenger is reminded to modify the destination or is refused the ride. After that, Intelligent Central System 2201 automatically controls Shuttle Body System 1201 to travel at the highest possible speed on Magnetic-Road System 1102 in Pipeline System 1101, from A Station straight to B Station without any stations/stops in between. Before arrival, Audio-Visual Interaction System 1207 automatically reminds passenger to get ready to get off the Shuttle (no need to worry about missing his/her stop, and no missing). When arriving at B Station, the door will open automatically and passenger can get off the Shuttle with their bags. And then the Shuttle will automatically park online at an appropriate location in the pipeline, waiting for restart commands. During running, passenger may sit, lie down, or work, may use Air Conditioning System 1205, Lighting System 1206, may use Audio-Visual Interaction System 1207 to amuse himself or herself, or to link up and interact with others, or to change his or her destination. During running, if Health Monitoring Trigger System 2503 finds that the passenger's body is abnormal, then Health Emergency Response System 3101 is triggered to alert the passenger and get in touch with the hospital and guardian, and if necessary, the emergency channel is directly opened and the route is changed to take the passenger to the nearest suitable hospital (assuming that the hospital has already set up a station/stop). During running, if Identification System 1210 further judges that the passenger has significant suspicion, it will automatically activate the Special Control System 2205 to notify the police for verification, and if the passenger is indeed a suspect, the police will determine the disposition of the passenger and automatically record the passenger's trajectories, and, if necessary, directly lock the door of the Shuttle to detain the suspect to the Public Security Bureau (assuming that the Public Security Bureau has already set up a station/stop); During running, in case of fire, automatically trigger Fire Emergency Response System 3103, and make an emergency stop, open the door, open the nearest Escape Route, automatically start the sprinkler system if necessary, or quickly drive away, exit or avoid the fire section in advance. The data related to the whole process is uploaded by Data System 41 through Communication System 23, directly to Intelligent Central System 2201, and stored in Data Storage System 4103.

### Implementation Example 2, Implementation of District STS and City STS

Based on Implementation Example 1, more stations/stops are added at different locations in Place A, and by connecting each station/stop by Pipe-Tunnel System 11, Place A apartment complex STS is formed. Usually, three stations/stops can form a District STS, and if the line to Place B is added, a larger District STS is formed, and so extended. The City STS is equivalent to a much larger District STS.

### Implementation Example 3, Implementation of Intercity STS

Based on Implementation Example 2, constructing an Intercity STS from a station in City C to a station in City D (referred to as C Station and D Station), it is only necessary to add a Pipe-Tunnel System 11 between the two stations/stops on the outer edges of the two City STS to connect the two cities, and to add some Intercity Service System 2402 at appropriate spacing along the way. Get on the Shuttle from C Station, then go through the City STS lane of City C, and then travel along Pipeline System 1101 between City C and City D. During running, the passenger may take a small break at some Intercity Service System 2402, and then, go through the City STS lane of City D, which can directly reach D Station. The full route is the best path with the shortest time duration, and the Shuttle can travel between cities at much higher speeds, and One-Stop Arrival. In the whole process, no need like 2TS: first take vehicle or drive from C Station—go to the train station or airport of City C for waiting—then take a high-speed train or a plane to the train station or airport of City D—take another vehicle to D Station.

### Implementation Example 4, Implementation of National STS or Global STS

The same manner of Implementation Example 3 is extended by analogy to all parts of the country or the world, constituting National STS or Global STS.

### Implementation Example 5, Implementation of Inserting Stations/Stops into Specific Areas and Implementation of P/C

If Pipe-Tunnel System 11 is extended to E Station in scenic area, tourists from all over the country will get on the Shuttles at his or her doorstop, and get off the Shuttle to reach E Station in scenic area. And if Pipe-Tunnel System 11 is extended to a school campus F Station, students or teachers get on the Shuttles at his or her doorstop, by Identification System 1210 judged to be the school's students or teachers, Shuttle will be directly into the campus, no longer cross the road, and idle people will not be able to enter the campus.

### Implementation Example 6, Implementation of the Fire Extinguishing Function

If the fire sensor at a point senses fire information, it triggers Fire Emergency Response System 3103, which, based on the sensed location, automatically activates the nearest sprinkler fire extinguishing function at that point, and at the same time, which automatically activates the entrance restriction function of the nearest G Station and H Station on both sides of that point, and automatically evacuates all shuttles in the GH section, automatically notifies related personnels to use manual operations of the emergency response plan.

### Implementation Example 7, Implementation of Online Parking Function

During low peak hours or other no temporary demand for Shuttle, Intelligent Central System 2201 automatically arranges online parking in the nearest online parking space for idle Shuttles, and can restart them at any time.

Implementation Example 8, Implementation of Transport Mode for Passengers from Different Locations in City J to Different Locations in City K (that is, all Weathers, One-Stop Arrival, De-Consolidation Transport)

Passengers at different locations in City J get on the Shuttles nearby, and their respective Shuttles automatically choose the road conditions and the best road sections to combine into the optimal routes, and One-Stop Arrival to reach their respective destinations (different locations in City K) directly without any stopping in the middle, and not to mention the need to first take a centralized high-speed rail or airplane in City J to City K and then transfer separately to reach their respective destinations. The detailed running process for each person is the same as in Implementation Example 3, where everyone has different starting and ending points and different routes and different departure times, all of which eliminate the need for centralized inbound, timed departures, stopping en route and centralized outbound trips. This example best exemplifies the efficiency, convenience, and freedom of STS.

### Implementation Example 9, Implementation of Peak Traffic Capacity Enhancement

At a Metro transfer station, the average daily morning peak inbound volume in 2019 was 26,200, with 60,700 transfers. After the implementation of STS, all stations/stops have equal advantages, the number of inbound trips is significantly reduced, no transfers are required, and the number of transfers is reduced to 0 people.

Again, on a major urban roadway, the morning peak hour traffic volume is 19,630 pcu/hour and the evening peak hour traffic volume is 16,457 pcu/hour. After the implementation of STS, the hourly traffic flow is a minimum of 150,000 pcu/hour for a non-major section with 6 lanes in both directions. As can be seen, the regular capacity of the non-major sections of STS is 7.6-9.1 times the peak capacity of the major sections of 2TS.

### INDUSTRIAL UTILITY

The invention herein has a strong industrial utility, which is demonstrated by the following aspects:

The invention herein solves the traffic problems that is currently a common face and urgent problems worldwide.

The technologies used in this invention are all current mature technologies and feasible technologies, with fewer components, simpler process, lower cost, resource saving.

The invention herein solves the dual-carbon problems and energy problems faced by mankind at the same time as it solves the problem of transportation vehicles and Traffic Systems.

The invention herein can be applied both locally (e.g., a peak section, a district, between two cities, etc.) and/or globally (e.g., a city, a country, etc.). From local to global application, it is only necessary to continuously assemble, extend and nest the standard Pipe-Tunnel System to cover a larger area, forming a larger regional STS, and finally realizing global access.

The larger the application of the invention, i.e., the more stations/stops, the more pronounced its beneficial effects become. Suppose there are n stations/stops, which have the same significance as the number of lines between two points, growing in a Permutation P (2, n) style.

1. Internet of things-based green traffic system for civil-military integration (GTS), specifically referring to land transportation, characterized in that:
said GTS's parent system components comprise:
a cabin-tunnel system,
a control-safeguard system,
a data system,
an emergency response system;
said GTS, characterized by:
a framework structure adopted to subvert completely the current traffic system,
wherein,
an intelligent consortium model adopted to separate the risks of
an intelligent cabin, and to interconnect information;
an operation mode adopted to subvert the current traffic system,
wherein,
a de-consolidation transport mode adopted to break up the whole load into pieces and to achieve lightweight and fast transportation;
an integrated adoption of
an intelligent control system,
a cloud data system,
said automatic emergency response system,
a cloud payment, and
military-police-civilian integration sharing to ultimately realize a safe, efficient, high-speed and convenient military-civilian integration GTS.

2. Said GTS as claimed in claim 1, wherein, said framework structure, further characterized by:
in terms of structure,
a pipeline adopted to separate high-risk of said intelligent cabin for moving transportation in GTS from other non-moving elements controlling and serving the transportation,
in terms of information interaction and control command,
a basis of IoT technology,
a method of information interaction with IoT+Internet+communication network+big data, and
said intelligent control system used to interconnect the constituent elements of the GTS and to control them,
in said framework structure,
a separation mode of transportation and control presented as said intelligent consortium mode.

3. Said GTS as claimed in claim 1, wherein, said operation mode, further characterized by:
a one-stop arrival of said efficient de-consolidation transport mode realized by using:
a micro shape of said intelligent cabin,
a bulk passenger stations/stops,
a magnetic levitation and magnetic drive,
said one-stop arrival transportation,
driverless,
no stops,
unlimited speed,
online driving,
online parking,
an instant-response parking mode,
de-visualized travel signal signs,
unmanned, and
a management and control mode of
an intelligent joint control.

4. Said GTS as claimed in claim 1 or claim 2 or claim 3, wherein, said intelligent cabin, characterized by:
said intelligent cabin, comprising:
a cabin body system,
a levitation-driving system,
a standby driving system,
an in-cabin positioning system,
an air conditioning system,
a lighting system,
an audio-visual interaction system,
an in-cabin sensing system,
a safety system of said intelligent cabin,
an identification system,
a communication system of said intelligent cabin,
said intelligent control system of said intelligent cabin,
a wiring harness system, and
a seat system of passenger;
said intelligent cabin, further characterized by:
a lightweight miniature streamlined body of said intelligent cabin,
said intelligent cabin to be the inseparable part of the total invention conception of GTS,
said intelligent cabin controlled by
said intelligent control system,
said cabin body system divided into
a passenger intelligent cabin, and
a cargo intelligent cabin,
a load not exceeding 4 persons,
an optimized load for 1+1 persons or limited cargo,
using of new energy source, said magnetic levitation and magnetic drive, and driverless,
said intelligent cabin capable connected to each other,
said intelligent cabin capable operated 24/7 in all-weather with said unlimited speed in
an enclosed pipeline,
and
a dynamic adjustments of driving routes and speeds in real time due to road conditions, and changing dynamically,
said dynamic adjustments based on
a principle of:
a shortest time duration,
a no stopping en route, and
an optimal utilization of system resources,
said intelligent control system making judgment and sending out commands.

5. Said GTS as claimed in claim 1 or claim 2 or claim 4, wherein, said intelligent control system, characterized in that:
said intelligent control system, comprising:
an intelligent central system,
a manual control system,
a human-computer interaction system,
a user control system, and
a special control system;
said intelligent control system, characterized by:
these systems can be a complete control system, but also can be the total control system under the function of each part, which is determined by the user or control object to determine the characteristics of its use, and not necessarily independent of each other;
said intelligent control system acquires the information data of each constituent part of the GTS sensed by the IoT through the communication system, and controls the synergistic operation of each IoT constituent part of the GTS through the communication system, to form a manual-free, fully automated, and jointly controlled control mode, in order to optimize in real time the optimal principles of non-stop routes, resource utilization and system balance of all said intelligent cabins to form an accurate and efficient intelligent control software system.

6. Said GTS as claimed in claim 2, wherein, said pipeline, characterized in that:
In all the transportation lines, the enclosed or semi-enclosed pipeline used as a protective shielding body, which completely separating the high-risk of moving said intelligent cabin from the outside world, such as pedestrians, other vehicles, weather influences, and said intelligent control system;
in said pipeline,
a magnetic-road system laid out,
no visualization of traffic signal signs,
and full intersection interchanges,
for
greatly reducing the cause of accidents, completely blocking the cause chain formed by this important cause of high-speed moving said intelligent cabin and the risks it brings,
and
said pipeline constituting a totally enclosed, all-day, all-weather, no-stop, no-speed-limit, no-artificial, no-obstacle, no-risk, and safety channel.

7. Said GTS as claimed in claim 3, wherein, said stations/stops, characterized in that:
said stations/stops implanted in specific areas to form
a seamless connection with other transportation modes or areas.

8. Said GTS as claimed in claim 4, wherein, said in-cabin sensing system and said identification system, characterized in that:
said in-cabin sensing system and said identification system sensing the information data of said intelligent cabin, passenger and cargo, and according to these information,
said intelligent control system determining passenger and cargo identity, status, priority and/or concession, military and police affairs, and send appropriate commands in due course.

9. Said GTS as claimed in claim 5, wherein, said special control system, characterized in that:
a dedicated system for the military and police,
civil-military integration using,
and both in peacetime and wartime.
